(19) United States
(12) Patent Application Publication
(10) Pub. No.: US 2022/0244998 A1
(43) Pub. Date: Aug. 4, 2022

(54) METHOD AND APPARATUS FOR ACQUIRING DEVICE INFORMATION, STORAGE MEDIUM AND ELECTRONIC DEVICE

(71) Applicant: VirtAI Technologies (Beijing) Co., Ltd., Beijing (CN)

(72) Inventor: Guohao DAI, Beijing (CN)

(21) Appl. No.: 17/620,635

(22) PCT Filed: Jun. 10, 2020
(86) PCT No.: PCT/CN2020/095402

§ 371 Date: Dec. 17, 2021

(30) Foreign Application Priority Data
Jun. 26, 2019 (CN) 201910562309.2

(51) Int. Cl. G06F 9/50

(52) U.S. Cl. CPC G06F 9/5044; G06F 2209/5011; G06F 9/5033; G06F 9/5061

(57) ABSTRACT

The present disclosure relates to a resource allocation method and device, electronic equipment, and a storage medium so as to solve the problems of inflexible resource allocation and low resource utilization rate in the related art. The resource allocation method is applied to the terminal equipment and comprises: sending a resource application request to a resource management server, wherein the resource application request comprises grouping information of processes running on the terminal equipment, and the grouping information is used by the resource management server to select, from a preset resource pool, resources allocated to each group of processes indicated by the grouping information (S201); and receiving resources returned by the resource management server, and allocating the received resources to each group of processes (S202).

### CROSS-REFERENCE TO RELATED APPLICATIONS

The present disclosure is a U.S. national phase of International Patent Application Serial No. PCT/CN2020/095402 filed on Jun. 10, 2020, which claims the benefit of Chinese Patent Application No. 201910562309.2 filed on Jun. 26, 2019, the contents of the which are incorporated by reference in their entireties.

### TECHNICAL FIELD

The present disclosure relates to the field of information technologies, in particular to a resource allocation method and device, electronic equipment and a storage medium.

### BACKGROUND

Resource pooling is a relatively popular technology in cloud computing and data centers and aims to centrally manage resources originally statically allocated to each terminal equipment to form a resource pool. Through communication means such as a network, the resource pool may be accessed and shared by the whole cloud server or data center. When an application or a process of the terminal equipment needs to use resources, a certain quantity of resources may be applied for from the resource pool according to a certain rule, and the applied resources are used through a resource abstraction interface. Correspondingly, a resource management server for managing the resource pool can subtract the corresponding number of the resources from the allocable resources in the resource pool after allocating the resources to the application or the process and can increase the corresponding allocable resources only when the application or the process returns the resources through the resource abstraction interface.

In the related art, the terminal equipment is generally used as a unit for applying for the resources to apply for the resources from the resource management server. Taking FIG. 1 as an example, specifically, a process 0 and a process 1 run on the terminal equipment; and when the resources need to be applied for, the terminal equipment sends a resource application request to the resource management server according to the running status of the process 0 and the process 1. In response to receiving the resource application request, the resource management server selects resources vRes0-vRes2 from a preset resource pool (containing resources vRes0-vRES7) and allocates them to the terminal equipment.

### SUMMARY

An objective of the present disclosure is to provide a resource allocation method and device, electronic equipment and a storage medium so as to solve the problems of inflexible resource allocation and low resource utilization.

In order to achieve the above objective, according to a first aspect of the examples of the present disclosure, a resource allocation method which is applied to terminal equipment is provided, including:

sending a resource application request to a resource management server, the resource application request includes grouping information of processes running on the terminal equipment, and the grouping information is used by the resource management server to select resources allocated to each group of processes indicated by the grouping information from a preset resource pool; and

receiving resources returned by the resource management server, and allocating the received resources to each group of processes.

The method further comprises: before sending the resource application request to the resource management server,

for any application group, determining the identification information of the application group by:

generating a universal unique identifier (UUID) according to identification information corresponding to the target grouping mode and process information in the application group, and taking the UUID as the identification information of the application group; or

splicing the identification information corresponding to the target grouping mode, the process information in the application group, and identification information of the operating system of the terminal equipment to obtain the identification information of the application group.

According to a second aspect of the examples of the present disclosure, a resource allocation method which is applied to a resource management server is provided, including:

in response to receiving a resource application request sent by a terminal equipment, selecting, from a preset resource pool, resources allocated to each group of processes indicated by grouping information in the resource application request according to the grouping information; and

sending the selected resources to the terminal equipment to indicate the terminal equipment to allocate the resources to each group of processes.

According to a third aspect of the examples of the present disclosure, a resource allocation device which is applied to a terminal equipment is provided, including:

a first sending module, configured to send a resource application request to a resource management server, the resource application request includes group information of processes running on the terminal equipment, and the group information is used by the resource management server to select resources allocated to each group of processes indicated by the group information from a preset resource pool; and

a receiving module, configured to receive resources returned by the resource management server and allocate the received resources to each group of processes.

According to a fourth aspect of the examples of the present disclosure, a resource allocation device which is applied to a resource management server is provided, including:

an allocation module, configured to select, from a preset resource pool, resources allocated to each group of processes indicated by grouping information in a resource application request according to the grouping information, in response to receiving the resource application request sent by a terminal equipment; and

a second sending module, configured to send the selected resources to the terminal equipment.

According to a fifth aspect of examples of the present disclosure, a computer-readable storage medium is provided storing computer programs thereon. and the steps of the method according to the first or second aspect are implemented when the programs are executed by a processor.

According to a sixth aspect of an example of the present disclosure, an electronic equipment is provided, including:

a memory, having computer programs stored thereon; and

a processor, configured to execute computer programs in the memory to implement the steps of the method according to the first or second aspect.

The technical solution provided by the examples of the present disclosure may have the following beneficial effects that: when the terminal equipment sends the resource application request to the resource management server, the resource application request carries the grouping information about the running application so that the resource management server allocates the resources for each group of processes according to the grouping information. Compared with a mode of applying and allocating the resources in the unit of the whole terminal equipment in the prior art, such mode of applying and allocating the resources in the unit of group is more flexible and is more timely to release the resources in the resource pool; and through such resource allocation method, the processes belonging to the same group on the terminal equipment use the same resources, and the processes belonging to different groups use different resources, so that the resource utilization rate in the resource pool may be improved.

It should be understood that both the foregoing general description and the following detailed description are examples and explanatory only, and are not intended to limit the present disclosure.

Other features and advantages of the present disclosure will be described in detail in the following forth in the detailed description of the present disclosure.

### BRIEF DESCRIPTION OF DRAWINGS

The accompanying drawings, which are included to provide a further understanding of the present disclosure and constitute a part of this description, together with the detailed description serve to explain the present disclosure, but do not constitute a limitation of the present disclosure. In the drawings:

FIG. 1 is a schematic diagram illustrating a resource allocation mode in accordance with an example;

FIG. 2 is a flowchart illustrating a resource allocation method according to an example, wherein the resource allocation method is applied to terminal equipment;

FIG. 3 is a schematic diagram illustrating another resource allocation mode in accordance with an example;

FIG. 4 is a schematic diagram illustrating yet another resource allocation mode in accordance with an example;

FIG. 5 is a flowchart illustrating a resource allocation method in accordance with an example, wherein the resource allocation method is applied to a resource management server;

FIG. 6 is a signaling interaction diagram illustrating a resource allocation method in accordance with an example;

FIG. 7 is a signaling interaction diagram illustrating yet another resource allocation method in accordance with an example;

FIG. 8 is a signaling interaction diagram illustrating yet another resource allocation method in accordance with an example;

FIG. 9 is a block diagram illustrating a resource allocation device in accordance with an example, wherein the resource allocation device is applied to terminal equipment;

FIG. 10 is a block diagram illustrating yet another resource allocation device in accordance with an example, wherein the resource allocation device is applied to terminal equipment;

FIG. 11 is a block diagram illustrating a resource allocation device in accordance with an example, wherein the resource allocation device is applied to a resource management server;

FIG. 12 is a block diagram illustrating an electronic equipment in accordance with an example, wherein the electronic equipment is provided as terminal equipment;

FIG. 13 is a block diagram illustrating an electronic equipment in accordance with an example, wherein the electronic equipment is provided as a server.

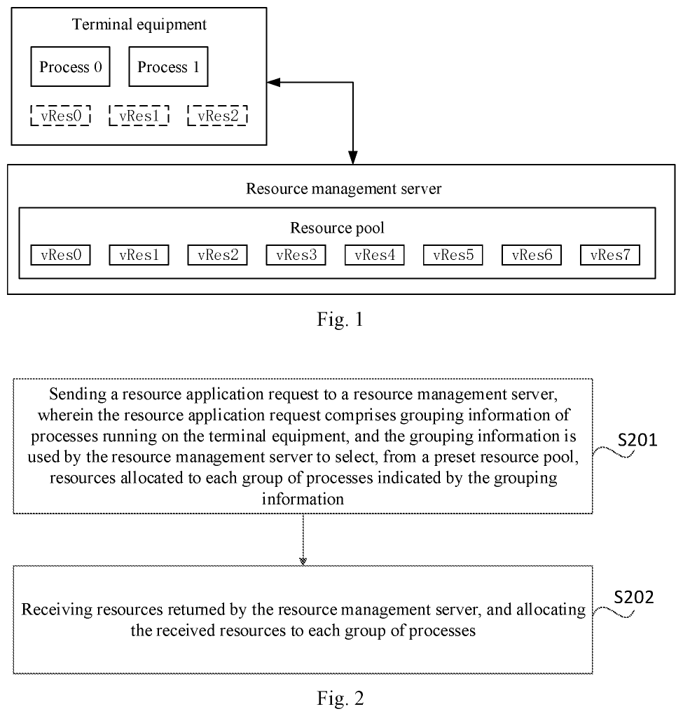

### DETAILED DESCRIPTION

The detailed description of the present disclosure is described in detail below in combination with the accompanying drawings. It should be understood that the detailed description described herein are given by way of illustration and explanation only for the present disclosure but not intended to limit the present disclosure.

It should be noted that the terms “first,” “second” and the like in the description and claims of the present disclosure and in the foregoing drawings are used for distinguishing between similar objects and are not necessarily understood as a particular sequential or chronological order.

The example of the present disclosure provides a resource allocation method which is applied to terminal equipment. As shown in FIG. 2, FIG. 2 is a flowchart illustrating a resource allocation method according to an example, and the method includes the following steps:

S201, sending a resource application request to a resource management server, the resource application request includes grouping information of processes running on the terminal equipment, and the grouping information is used by the resource management server to select resources allocated to each group of processes indicated by the grouping information from a preset resource pool.

The resources involved in the example of the present disclosure may include a vCPU, a memory, a network traffic and the like, which is not limited in the example of the present disclosure.

The grouping information may include application group information (e.g., the number of application groups) in the terminal equipment, process information (e.g., the number of the processes) contained in each application group, the number of required resources and the like, which is not limited in the example of the present disclosure.

S202, receiving resources returned by the resource management server, and allocating the received resources to each group of processes.

The terminal equipment may allocate the received resources to each group of processes, so that processes belonging to the same group use the same resources and processes in different groups use different resources.

By the resource allocation method provided by the above example, when the terminal equipment sends the resource application request to the resource management server, the resource application request carries the grouping information about the running application so that the resource management server allocates the resources for each group of processes according to the grouping information. Compared with a mode of applying and allocating the resources in the unit of the whole terminal equipment in the prior art, such mode of applying and allocating the resources in the unit of group is more flexible and is more timely to release the resources in the resource pool; and through such resource allocation method, the processes belonging to the same group on the terminal equipment use the same resources, and the processes in different groups use different resources, so that the resource utilization rate in the resource pool may be improved.

In another example of the present disclosure, the resource allocation method may further include: before sending the resource application request to the resource management server, the terminal equipment groups the running progresses according to computing task information and the like currently executed by the terminal equipment to obtain one or more application groups and process information contained in each application group.

The computing task information may include task attributes and computation amount of the computing task. The terminal equipment determines a target grouping mode of the processes running on the terminal equipment according to the task attribute and the computation amount of the computing task currently executed by the terminal equipment and a preset corresponding relationship among the task attribute, the computation amount and the grouping mode, and divides the processes running on the terminal equipment into one or more application groups according to the target grouping mode.

The grouping mode may include, but is not limited to, the following modes: \textcircled{1} taking each process as one application group; \textcircled{2} dividing processes belonging to the same process group into one application group; \textcircled{3} dividing processes belonging to the same session into one application group; \textcircled{4} dividing processes belonging to the same user into one application group; \textcircled{5} divide all the processes into one application group, and the like.

The task attribute of the computing task may include a resource allocation limitation requirement, an output timeliness requirement, a unified management requirement and the like for the computing task. The task attribute may also be any other types, and the example of the present disclosure is not limited thereto.

The corresponding relationship among the task attribute, the computation amount and the grouping mode may be set as needed, for example, Table 1 shows an example of the corresponding relationship.

TABLE 1

| Grouping mode | Task attribute | Computation amount |
|---|---|---|
| Grouping mode \textcircled{1} | Having output timeliness | Big |
| | requirement | |
| Grouping mode \textcircled{2} | Having resource allocation | Medium |
| | limitation | |
| Grouping mode \textcircled{3} | Having resource allocation | Small |
| | limitation and unified | |
| | management requirement | |
| Grouping mode \textcircled{4} | | |
| . . . | . . . | . . . |

In the specific implementation of grouping the processes running on the terminal equipment, in the case that the target grouping mode is the grouping mode \textcircled{1}, since the process is the smallest task unit for distinguishing independent tasks by an operating system (such as Linux and Windows) of the terminal equipment, the operating system will allocate a process ID unique to the whole system for each process, for example, the process ID of the process 0 is 1555, and the ID of the process 1 is 1999. Based on this, the processes running on the terminal equipment may be grouped according to the processes ID, and the processes with the same process ID are assigned to the same application group.

In the case that the target grouping mode is the grouping mode \textcircled{2}, since the operating system may usually support process forking during running of one process, that is, a new process that runs independently is forked so as to improve the running parallelism of an application, and in order to record such parent-child relationship, the operating system may allocate a process group ID unique to the whole system to the processes having such parent-child relationship so as to characterize that these processes belong to the same process group. Based on this, the processes running on the terminal equipment may be grouped according to the process group ID, and the processes with the same process group ID are assigned to the same application group.

In the case that the target grouping mode is the grouping mode \textcircled{3}, since the operating system may usually also support multiple login interfaces, in order to facilitate management of each login interface, the operating system may allocate a session group ID unique to the whole system to the processes having the same login interface so as to characterize that these processes belong to the same session. Based on this, the processes running on the terminal equipment may be grouped according to the session group ID, and the processes with the same session group ID are assigned to the same application group.

In the case that the target grouping mode is the grouping mode \textcircled{4}, since the operating system may further support multiple users to use, each user corresponds to a unique ID in the operating system. Based on this, which user ID each process corresponds to may be queried through relevant interface of the operating system, and the processes with the same user ID are assigned to the same application group according to the grouping of user IDs.

The resource allocation method provided by this example is explained below with two examples.

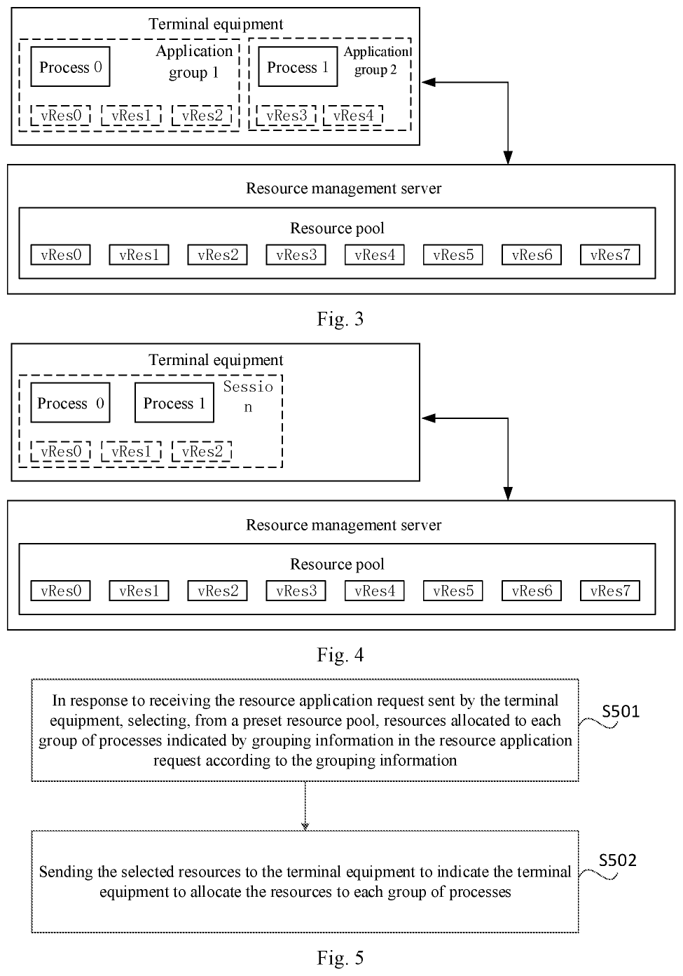

FIG. 3 and FIG. 4 show different grouping modes with an example that the process 0 and the process 1 run on the terminal equipment and the resource pool of the resource management server includes resources vRes0-vRes7. As shown in FIG. 3, in the case that the terminal equipment currently executes a computing task with a large computation amount and a high output timeliness requirement, the target grouping mode may be determined to be the grouping mode \textcircled{1}, and resources are applied for from the resource management server in the unit of process (i.e., process 0 belongs to an application group 1, and process 1 belongs to an application group 2), and the resource management server allocates resources vRes0-vRes2 to the application group 1 and allocates resources vRes3-vRes4 to the application group 2 according to the grouping information. In this way, the execution parallelism of the computing tasks on the terminal equipment may be improved, so that the execution efficiency of the task is improved, and the computing task is ensured to meet the output timeliness requirement.

As shown in FIG. 4, in the case that the terminal equipment currently executes a computing task with the resource allocation limitation and the unified management requirement, the target grouping mode may be determined to be the grouping mode \textcircled{3}, resources are applied for from the resource management server in the unit of session (i.e., process 0 and process 1 belonging to the same session belong to the same application group), and the resource management server allocates resources vRes0-vRes2 to the application group 1 according to grouping information. In this way, the resources used by each process are limited, so that the resource allocation limitation requirement is met, and the resource utilization rate in the resource pool may be improved.

In the resource allocation method provided by this example, when the terminal equipment sends the resource application request to the resource management server, the resource application request carries the grouping information of the running application so that the resource management server allocates the resources for each group of processes according to the grouping information. Compared with a mode of applying and allocating the resources in the unit of the whole terminal equipment in the prior art, such mode of applying and allocating the resources in the unit of group is more flexible and is more timely to release the resources in the resource pool; and through such resource allocation method, the processes belonging to the same group on the terminal equipment use the same resources, and the processes in different groups use different resources, so that the resource utilization rate in the resource pool may be improved.

Moreover, the terminal equipment selects a corresponding target grouping mode according to the task attribute and the computation amount of the computing task currently executed by the terminal equipment, and the running processes are grouped according to the target grouping mode to obtain a plurality of application groups; and such grouping mode may adapt to the demands under different application scenarios, so that the flexibility of resource allocation is further improved, and the resource utilization rate is further improved.

In another example of the present disclosure, the grouping information may further include identification information of each application group, so that the resource management server allocates the resources to each application group according to the identification information of each application group. Correspondingly, the example is further improved on the basis of the foregoing examples, and the specific improvement is as follows: the terminal equipment divides the running processes into one or more application groups according to the target grouping mode, and then generates corresponding identification information for each application group.

In a first optional implementation, for each application group, a universal unique identifier (UUID) is generated according to the identification information corresponding to the target grouping mode and the process information in the application group, and the UUID is used as the identification information of the application group;

wherein each grouping mode corresponds to preset identification information. For example, the identification information corresponding to the grouping mode \textcircled{1} may be SB0, the identification information corresponding to the grouping mode \textcircled{2} may be SB1, and so on.

The process information in the application group may be any one of the following information: a process ID of the process, a process group ID to which the process belongs, a session ID to which the process belongs, a user ID to which the process belongs, identification information of an operating system to which the process belongs and the like.

For example, for each application group, in the case that the target grouping mode is the grouping mode \textcircled{1}, a UUID may be generated according to the identification information SB0 corresponding to the target grouping mode and the process IDs of the processes in the application group; in the case that the target grouping mode is the grouping mode \textcircled{2}, a UUID may be generated according to the identification information SB1 corresponding to the target grouping mode and the process group ID to which the processes in the application group belong, and so on.

It should be noted that, in order to ensure that all the processes in the same application group can obtain the same UUID regardless of concurrent execution or serial execution, the UUID may be generated as follows for each application group:

(1) a candidate identifier is obtained according to the identification information corresponding to the target grouping mode of the application group and the process information contained in the application group. For example, if the target grouping mode is the grouping mode \textcircled{1}, the candidate identifier of the application group is {SB0, process ID}. All the processes within the application group use the same candidate identifier.

(2) For any process in the application group, a file is created on a disk of the terminal equipment through an interface of the operating system, a directory or other mapping relationship Path is set, and the location of the file is obtained according to the target or mapping relationship Path and the candidate identifier obtained in (1). Since the candidate identifiers of different application groups are different, the files created by the processes in different application groups are different. For example, if the target grouping mode is the mode \textcircled{1} described above, the location of the file is {Path, SB0, Process ID}.

(3) When one file is created, if a plurality of processes create the same file at the same time, only one process can create the file successfully, and other processes will receive a notification of creation failure to indicate that the file has been created by other processes. In this way, the file can be opened by either the process that successfully create the file or the processes that fail to create the file. That is, the plurality of processes in the same application group can open the same file, while the processes in different application groups can open different files.

(4) All the processes opening the same file add a “write lock” to the file through the interface of the operating system, indicating that the file is to be written. The operating system may ensure that at most one process can successfully obtain the “write lock”, while the other processes may fail. Specifically, in the case that any process has successfully added a “read lock” to the file, it indicates that the process is reading the file, and any other processes cannot add the “write lock” to the file.

(5) The processes that cannot obtain the “write lock” instead adds the “read lock” to the file through the interface of the operating system, indicating that the file is to be read. After any process successfully adds the “write lock” to the file, the operating system will block other processes from adding the “read lock” until the process that obtains the “write lock” releases the “write lock”.

(6) The process obtaining the “write lock” calls a preset UUID computing method to compute a corresponding UUID and writes the UUID into the file. For example, in the case that the target grouping mode is the grouping mode \textcircled{1}, the UUID is written in {Path, SB0, process ID}.

(7) The process obtaining the “write lock” changes the “write lock” into the “read lock”, indicating that the “write lock” is released. At this time, the other processes blocked at the “read lock” are resumed to be executed and read the UUID from the file. For example, in the case that the target grouping mode is the grouping mode \textcircled{1}, the UUID is read from {Path, SB0, process ID}.

The mode of generating the UUID may further be other modes known to those skilled in the art, and thus will not be described herein.

In a second optional implementation, considering that the resource pool is a global resource of a cloud server or a data center with coexistence of a plurality of operating systems, in order to ensure that identification information of different application groups is different and unique, the identification information of the operating systems may be added on the basis of identification information corresponding to a target grouping mode and process information in the application groups. Specifically, for each application group, the identification information corresponding to the target grouping mode, the process information in the application group and the identification information of the operating system of the terminal equipment are spliced to obtain the identification information of the application group.

The identification information of the operating system of the terminal equipment may be any one of the following information: a network IP address, a network hardware address of the operating system and the like.

For example, taking MS as the identification information of the operating system, for each application group, in the case that the target grouping mode is the grouping mode \textcircled{1}, the identification information of the application group may be obtained as {MS, SB0, process ID}; in the case that the target grouping mode is the grouping mode \textcircled{2}, the identification information of the application group may be obtained as {MS, SB1, process group ID}; in the case that the target grouping mode is the grouping mode \textcircled{3}, the identification information of the application group may be obtained as {MS, SB2, session ID}, and so on.

In the resource allocation method provided by this example, when the terminal equipment sends the resource application request to the resource management server, the resource application request carries the grouping information of the running application so that the resource management server allocates the resources for each group of processes according to the grouping information. Compared with a mode of applying and allocating the resources in the unit of the whole terminal equipment in the prior art, such mode of applying and allocating the resources in the unit of group is more flexible and is more timely to release the resources in the resource pool; and through such resource allocation method, the processes belonging to the same group on the terminal equipment use the same resources, and the processes in different groups use different resources, so that the resource utilization rate in the resource pool may be improved.

Moreover, the terminal equipment selects a corresponding target grouping mode according to the task attribute and the computation amount of a computing task currently executed by the terminal equipment, and groups the running processes according to the target grouping mode to obtain a plurality of application groups; and such grouping mode may adapt to the demands under different application scenarios, so that the flexibility of resource allocation is further improved, and the resource utilization rate is further improved.

Further, when the terminal equipment sends a resource application request to the resource management server, the resource application request further carries the identification information of each application group, and the identification information may be used as a unique identity of each application group, so that the resource management server may conveniently, rapidly and accurately distinguish and allocate resources to each application group.

The example of the present disclosure further provides a resource allocation method which is applied to a resource management server. As shown in FIG. 5, FIG. 5 is a flowchart illustrating a resource allocation method according to an example, and the method includes the following steps.

S501, in response to receiving a resource application request sent by a terminal equipment, selecting, from a preset resource pool, resources allocated to each group of processes indicated by grouping information in the resource application request according to the grouping information; and

S502, sending the selected resources to the terminal equipment to indicate the terminal equipment to allocate the resources to each group of processes.

The grouping information may include application group information (e.g., the number of application groups) in the terminal equipment and process information (e.g., the number of the processes, the resource consumption of the processes and the like) in each application group. The resource management server may determine the resources allocated to each application group according to the number of the application groups and the number of the processes contained in the application groups and return allocation results containing the resources and the application groups corresponding to the resources to the terminal equipment, so that the terminal equipment may correspondingly allocate these resources to each application group for use by the processes in each application group.

Further, the grouping information may further include identification information of each application group. The resource management server may allocate corresponding resources to each application group according to the identification information of each application group, and mark each resource with the identification information of its corresponding application group when returning the resources to the terminal equipment so as to indicate the terminal to allocate each resource to its corresponding application group.

It should be noted that, the mode that the resource management server allocates the corresponding resources to each application group according to the grouping information may be any one of the existing allocation methods or an improvement to existing allocation methods. How to allocate the resources according to the grouping information by the resource management server is not a focus of the present disclosure and is not described herein again.

According to the resource allocation method provided by the example of the present disclosure, the resource management server allocates the resources to the terminal equipment according to the grouping information of the processes running on the terminal equipment. Compared with a mode of applying and allocating the resources in the unit of the whole terminal equipment in the prior art, such mode of allocating the resources in the unit of group is more flexible and is more timely to release the resources in the resource pool. Through such resource allocation method, the processes belonging to the same group on the terminal equipment use the same resources, and the processes in different groups use different resources, so that the resource utilization rate in the resource pool may be improved.

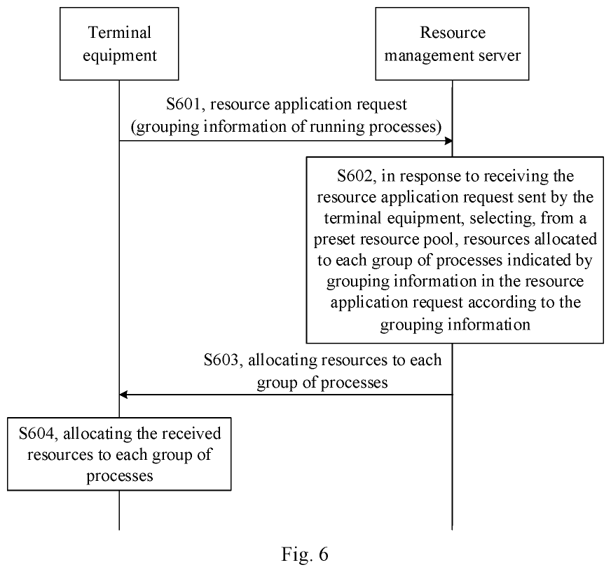

FIG. 6 is a signaling interaction diagram illustrating a resource allocation method in accordance with an example. In this example, the interaction parties involved include a terminal equipment and a resource management server, and the terminal equipment is in communication connection with the resource management server, a plurality of processes run on the terminal equipment, and a resource pool is preset in the resource management server and contains a plurality of allocable resources. As shown in FIG. 6, the resource allocation method includes the following steps:

S601, the terminal equipment sends a resource application request to the resource management server.

The resource application request includes grouping information of the processes running on the terminal equipment, and the grouping information may include application group information (e.g., the number of application groups), process information (e.g., the number of the processes, the resource consumption of the processes and the like), identification information of each application group and the like in the terminal equipment.

S602, in response to receiving the resource application request sent by the terminal equipment, the resource management server selects, from a preset resource pool, resources allocated to each group of processes indicated by the grouping information in the resource application request according to the grouping information.

S603, the resource management server sends the resources allocated to each group of processes to the terminal equipment.

S604, the terminal equipment allocates the received resources to each group of processes.

It should be noted that, the steps (such as steps S601 and S604) executed by the terminal equipment in this example may refer to the description of the corresponding steps in the above-mentioned resource allocation method executed by the terminal equipment, and the steps (such as steps S602 to S603) executed by the resource management server in this example may refer to the description of the corresponding steps in the above-mentioned resource allocation method executed by the resource management server, which are not described herein again.

In the resource allocation method provided in this example, when the terminal equipment sends the resource application request to the resource management server, the resource application request carries the grouping information of the running application so that the resource management server allocates the resources for each group of processes according to the grouping information. Compared with a mode of applying and allocating the resources in the unit of the whole terminal equipment in the prior art, such mode of applying and allocating the resources in the unit of group is more flexible and is more timely to release the resources in the resource pool. Through such resource allocation method, the processes belonging to the same group on the terminal equipment use the same resources, and the processes in different groups use different resources, so that the resource utilization rate in the resource pool may be improved.

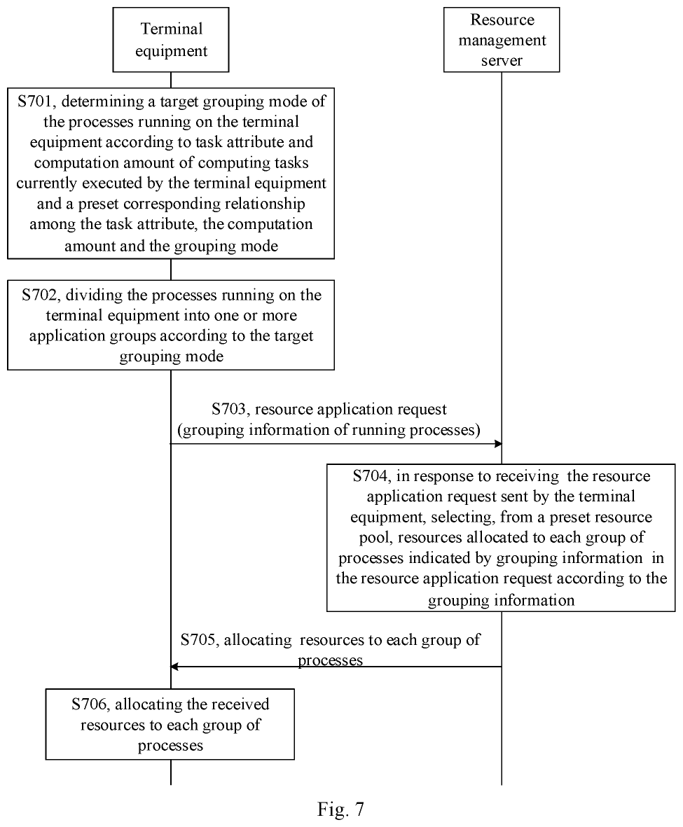

FIG. 7 is a signaling interaction diagram illustrating a resource allocation method in accordance with an example. In this example, the interaction parties involved include a terminal equipment and a resource management server. The terminal equipment is in communication connection with the resource management server, a plurality of processes run on the terminal equipment, and a resource pool is preset in the resource management server and contains a plurality of allocable resources. This example is further improved on the basis of the example shown in FIG. 6, and the specific improvements are as follows: before sending the resource application request to the resource management server, the terminal equipment groups the running progresses according to the information of the computing tasks and the like currently executed by the terminal equipment to obtain one or more application groups and process information contained in each application group.

As shown in FIG. 7, the resource allocation method includes the following steps:

S701, the terminal equipment determines a target grouping mode of the processes running on the terminal equipment according to task attribute and computation amount of computing tasks currently executed by the terminal equipment and a preset corresponding relationship among the task attribute, the computation amount and the grouping mode.

S702, the terminal equipment divides the processes running on the terminal equipment into one or more application groups according to the target grouping mode.

S703, the terminal equipment sends a resource application request to the resource management server.

The resource application request includes grouping information of the processes running on the terminal equipment, and the grouping information may include application group information (e.g., the number of application groups), process information (e.g., the number of the processes, the resource consumption of the processes and the like) and the like in the terminal equipment.

S704, in response to receiving the resource application request sent by the terminal equipment, the resource management server selects, from a preset resource pool, resources allocated to each group of processes indicated by the grouping information in the resource application request according to the grouping information.

S705, the resource management server sends the resources allocated to each group of processes to the terminal equipment.

S706, the terminal equipment allocates the received resources to each group of processes.

It should be noted that, the steps (such as steps S701 to S703, and S706) executed by the terminal equipment in this example may refer to the description of the corresponding steps in the above-mentioned resource allocation method executed by the terminal equipment, and the steps (such as steps S704 to S705) executed by the resource management server in this example may refer to the description of the corresponding steps in the above-mentioned resource allocation method executed by the resource management server, which are not described herein again.

In the resource allocation method provided in this example, when the terminal equipment sends the resource application request to the resource management server, the resource application request carries the grouping information of the running application so that the resource management server allocates the resources for each group of processes according to the grouping information. Compared with a mode of applying and allocating the resources in the unit of the whole terminal equipment in the prior art, such mode of applying and allocating the resources in the unit of group is more flexible and is more timely to release the resources in the resource pool. Through such resource allocation method, the processes belonging to the same group on the terminal equipment use the same resources, and the processes in different groups use different resources, so that the resource utilization rate in the resource pool may be improved.

Moreover, the terminal equipment selects a corresponding target grouping mode according to the task attribute and the computation amount of the computing tasks currently executed by the terminal equipment and groups the running processes according to the target grouping mode to obtain a plurality of application groups. Such grouping mode may adapt to the demands under different application scenarios, so that the flexibility of resource allocation is further improved, and the resource utilization rate is further improved.

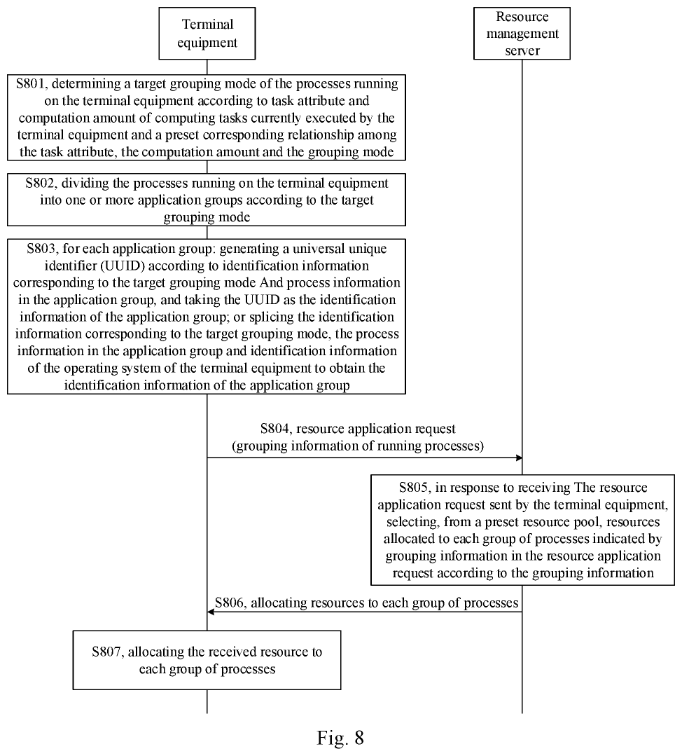

FIG. 8 is a signaling interaction diagram illustrating a resource allocation method in accordance with an example. In this example, the interaction parties involved include a terminal equipment and a resource management server. The terminal equipment is in communication connection with the resource management server, a plurality of processes run on the terminal equipment, and a resource pool is preset in the resource management server and contains a plurality of allocable resources. The example is further improved on the basis of the example shown in FIG. 7, and the specific improvements are as follows: the terminal equipment divides the running processes into one or more application groups according to the target grouping mode and then generates corresponding identification information for each application group.

As shown in FIG. 8, the resource allocation method includes the following steps:

S801, the terminal equipment determines a target grouping mode of the processes running on the terminal equipment according to task attribute and computation amount of computing tasks currently executed by the terminal equipment and a preset corresponding relationship among the task attribute, the computation amount and the grouping mode.

S802, the terminal equipment divides the processes running on the terminal equipment into one or more application groups according to the target grouping mode.

S803, the terminal equipment generates a universal unique identifier (UUID) for each application group according to the identification information corresponding to the target grouping mode and the process information in the application group and takes the UUID as the identification information of the application group; or the terminal equipment splices the identification information corresponding to the target grouping mode, the process information in the application group and the identification information of the operating system of the terminal equipment to obtain the identification information of the application group.

S804, the terminal equipment sends a resource application request to the resource management server.

The resource application request includes grouping information of the processes running on the terminal equipment, and the grouping information may include application group information (e.g., the number of application groups), process information (e.g., the number of the processes, the resource consumption of the processes and the like), and identification information of each application group and the like in the terminal equipment.

S805, in response to receiving the resource application request sent by the terminal equipment, the resource management server selects, from a preset resource pool, resources allocated to each group of processes indicated by the grouping information in the resource application request according to the grouping information.

S806, the resource management server sends the resources allocated to each group of processes to the terminal equipment.

S807, the terminal equipment allocates the received resources to each group of processes.

It should be noted that, the steps (such as steps S801 to S804, and S807) executed by the terminal equipment in this example may refer to the description of the corresponding steps in the above-mentioned resource allocation method executed by the terminal equipment, and the steps (such as steps S805 to S806) executed by the resource management server in this example may refer to the description of the corresponding steps in the above-mentioned resource allocation method executed by the resource management server, which are not described herein again.

In the resource allocation method provided in this example, when the terminal equipment sends the resource application request to the resource management server, the resource application request carries the grouping information of the running application so that the resource management server allocates the resources for each group of processes according to the grouping information. Compared with a mode of applying and allocating the resources in the unit of the whole terminal equipment in the prior art, such mode of applying and allocating the resources in the unit of group is more flexible and is more timely to release the resources in the resource pool. Through such resource allocation method, the processes belonging to the same group on the terminal equipment use the same resources, and the processes in different groups use different resources, so that the resource utilization rate in the resource pool may be improved.

Moreover, the terminal equipment selects a corresponding target grouping mode according to the task attribute and the computation amount of the computing tasks currently executed by the terminal equipment and groups the running processes according to the target grouping mode to obtain a plurality of application groups. Such grouping mode may adapt to the demands under different application scenarios, so that the flexibility of resource allocation is further improved, and the resource utilization rate is further improved.

Further, when the terminal equipment sends the resource application request to the resource management server, the resource application request further carries the identification information of each application group, and the identification information may be used as a unique identity of each application group, so that the resource management server may conveniently, rapidly and accurately distinguish and allocate resources to each application group.

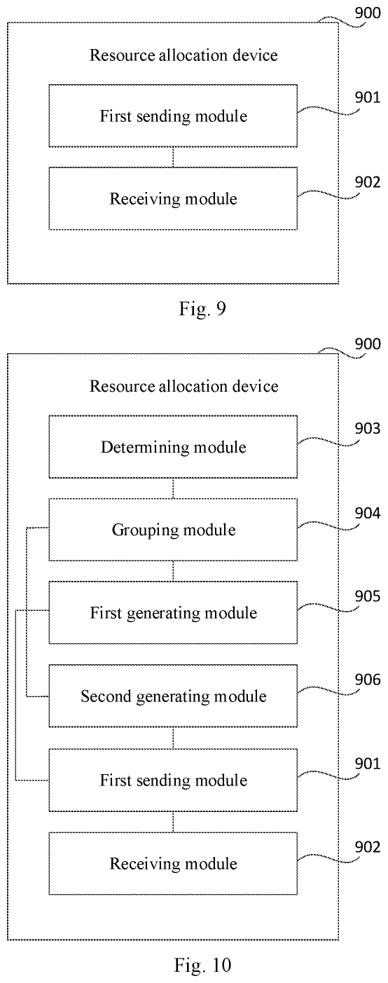

The example of the present disclosure further provides a resource allocation device which can be applied to a terminal equipment. As shown in FIG. 9, FIG. 9 is a block diagram illustrating a resource allocation device in accordance with an example, and the device 900 includes:

a first sending module 901, configured to send a resource application request to a resource management server, the resource application request includes group information of processes running on the terminal equipment, and the group information is used by the resource management server to select, from a preset resource pool, resources allocated to each group of processes indicated by the group information; and

a receiving module 902, configured to receive resources returned by the resource management server and distribute the received resources to each group of processes.

As shown in FIG. 10, the device 900 further includes:

a determining module 903, configured to determine a target grouping mode of the processes running on the terminal equipment according to task attribute and computation amount of computing tasks currently executed by the terminal equipment and a preset corresponding relationship among the task attribute, the computation amount and the grouping mode before the first sending module sends the resource application request to the resource management server; and

a grouping module 904, configured to divide the processes running on the terminal equipment into one or more application groups according to the target grouping mode.

Alternatively, the grouping mode includes:

taking each process as one application group;

dividing processes belonging to the same process group into one application group;

dividing processes belonging to the same session into one application group;

dividing processes belonging to the same user into one application groups; and

dividing all the processes into one application group.

Alternatively, the grouping information includes identification information of each application group.

As shown in FIG. 10, the device 900 further includes:

a first generating module 905, configured to generate a universal unique identifier (UUID) according to the identification information corresponding to the target grouping mode and take the UUID as the identification information of the application group; or

a second generating module 906, configured to splice the identification information corresponding to the target grouping mode and the identification information of the operating system of the terminal equipment to obtain the identification information of the application group.

It is obvious to those skilled in the art that, for convenience and simplicity of description, the foregoing division of each functional module is merely used as an example, and in practical applications, the above function distribution may be performed by different functional modules as needed, that is, the internal structure of the device is divided into different functional modules to perform all or part of the above described functions.

With regard to the device in the above examples, the specific manner in which each module performs the operation has been described in detail in the examples related to the method and will not be described in detail here.

By adopting the resource allocation device provided by the above examples, when the terminal equipment sends the resource application request to the resource management server, the resource application request carries the grouping information of the running application so that the resource management server allocates the resources for each group of processes according to the grouping information. Compared with a mode of applying and allocating the resources in the unit of the whole terminal equipment in the prior art, such mode of applying and allocating the resources in the unit of group is more flexible and is more timely to release the resources in the resource pool. Through such resource allocation method, the processes belonging to the same group on the terminal equipment use the same resources, and the processes in different groups use different resources, so that the resource utilization rate in the resource pool may be improved.

Moreover, the terminal equipment selects a corresponding target grouping mode according to the task attribute and the computation amount of the computing tasks currently executed by the terminal equipment and groups the running processes according to the target grouping mode to obtain a plurality of application groups. Such grouping mode may adapt to the demands under different application scenarios, so that the flexibility of resource allocation is further improved, and the resource utilization rate is further improved.

Further, when the terminal equipment sends the resource application request to the resource management server, the resource application request further carries the identification information of each application group, and the identification information may be used as a unique identity of each application group, so that the resource management server may conveniently, rapidly and accurately distinguish and allocate resources to each application group.

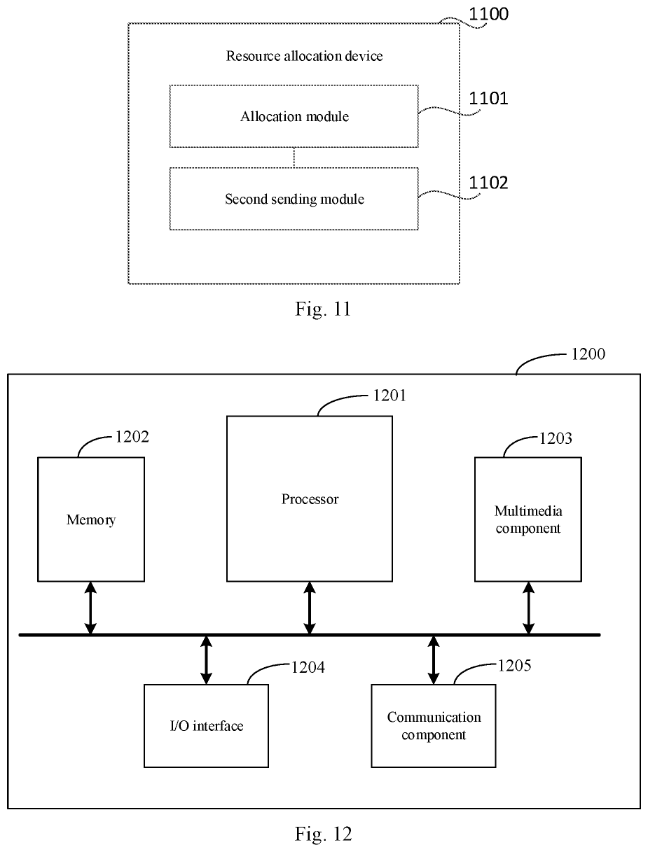

The example of the present disclosure further provides a resource allocation device which can be applied to a resource management server. As shown in FIG. 11, FIG. 11 is a block diagram illustrating a resource allocation device in accordance with an example, and the device 1100 includes:

an allocation module 1101, configured to select, from a preset resource pool, resources allocated to each group of processes indicated by grouping information in a resource application request according to the grouping information, in response to receiving the resource application request sent by a terminal equipment; and

a second sending module 1102, configured to send the selected resources to the terminal equipment.

It is obvious to those skilled in the art that, for convenience and simplicity of description, the foregoing division of each functional module is merely used as an example, and in practical applications, the above function distribution may be performed by different functional modules as needed, that is, the internal structure of the device is divided into different functional modules to perform all or part of the above described functions.

With regard to the device in the above examples, the specific manner in which each module performs the operation has been described in detail in the examples related to the method and will not be described in detail here.

According to the resource allocation method provided by the example of the present disclosure, the resource management server allocates the resources to the terminal equipment according to the grouping information of the processes running on the terminal equipment. Compared with a mode of applying and allocating the resources in the unit of the whole terminal equipment in the prior art, such mode of allocating the resources in the unit of group is more flexible and is more timely to release the resources in the resource pool. Through such resource allocation method, the processes belonging to the same group on the terminal equipment use the same resources, and the processes in different groups use different resources, so that the resource utilization rate in the resource pool may be improved.

The present disclosure further provides a computer readable storage medium on which computer program instructions are stored. The program instructions implement the steps of the resource allocation method provided by the present disclosure when being executed by a processor.

The example of the present disclosure further provides an electronic equipment, including: a memory, having computer programs stored thereon; and a processor, configured to execut the computer programs in the memory to implement the steps of the resource allocation method provided by the present disclosure.

FIG. 12 is a block diagram illustrating an electronic equipment 1200 in accordance with an example. For example, the electronic equipment 1200 may be provided as terminal equipment. As shown in FIG. 12, the electronic equipment 1200 may include: a processor 1201 and a memory 1202. The electronic equipment 1200 may further include one or more of a multimedia component 1203, an input/output (I/O) interface 1204 and a communication component 1205.

The processor 1201 is configured to control the overall operation of the electronic equipment 1200 so as to complete all or part of the steps in the resource allocation method performed by the terminal equipment. The memory 1202 is configured to store various types of data to support operation of the electronic equipment 1200, and the data, for example, may include an instruction for any application or method operating on the electronic equipment 1200 and application-related data, for example, contact data, messaging, pictures, audio, video, and the like. The memory 1202 may be implemented by any type or combination of volatile and non-volatile memory devices, for example, a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk. The multimedia component 1203 may include a screen and an audio component, wherein the screen may be, for example, a touch screen, and the audio component is configured to output and/or input an audio signal. For example, the audio component may include a microphone for receiving an external audio signal. The received audio signal may further be stored in the memory 1202 or sent through the communication component 1205. The audio component further includes at least one speaker for outputting the audio signal. The I/O interface 1204 provides an interface between the processor 1201 and other interface modules, and other interface modules may be keyboards, mouses, buttons and the like. These buttons may be virtual buttons or physical buttons. The communication component 1205 is used for wired or wireless communication between the electronic equipment 1200 and other equipment. Wireless Communication, for example, Wi-Fi, Bluetooth, Near field communication (NFC), 2G, 3G or 4G, or a combination of one or more of them, and thus the corresponding communication component 1205 may include a Wi-Fi module, a bluetooth module and a NFC module.

In an example, the electronic equipment 1200 may be implemented by one or more of application specific integrated circuits (ASIC), digital signal processors (DSP), digital signal processing devices (DSPD), programmable logic devices (PLD), field programmable gate arrays (FPGA), controllers, microcontrollers, microprocessors or other electronic elements and may be configured to perform the above-described resource allocation method performed by the terminal equipment.

In another example, a computer readable storage medium including program instructions is further provided. The program instructions implement the steps of the resource allocation method performed by the terminal equipment described above when being executed by the processor. For example, the computer readable storage medium may be the above-mentioned memory 1202 including the program instructions executable by the processor 1201 of the electronic equipment 1200 to perform the above-mentioned resource allocation method performed by the terminal equipment.

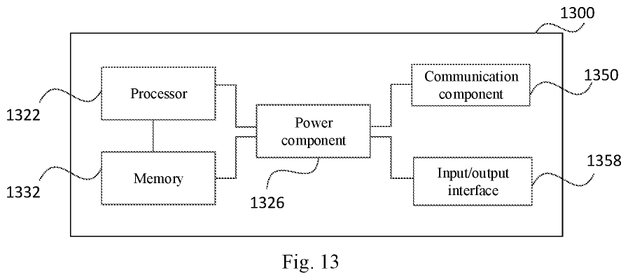

FIG. 13 is a block diagram illustrating electronic equipment 1300 in accordance with an example. For example, electronic equipment 1300 may be provided as a server. Referring to FIG. 13, the electronic equipment 1300 includes one or more processors 1322 and a memory 1332 for storing computer programs executable by the processors 1322. The computer program stored in the memory 1332 may include one or more modules, each of which corresponds to a set of instructions. Furthermore, each processor 1322 may be configured to execute the corresponding computer program to perform the resource allocation method performed by the resource management server.

Furthermore, the electronic equipment 1300 may further include a power component 1326 and a communication component 1350, wherein the power component 1326 may be configured to perform power management for the electronic equipment 1300, and the communication component 1350 may be configured to implement communication, for example, wired or wireless communication, for the electronic equipment 1300. Furthermore, the electronic equipment 1300 may further include an input/output (I/O) interface 1358. The electronic equipment 1300 may operate based on an operating system stored in the memory 1332, such as Windows Server™, Mac OS X™, Unix™, Linux™ and the like.

In another example, a computer readable storage medium is further provided including program instructions. The program instructions implement the steps of the resource allocation method performed by the resource management server described above when being executed by a processor. For example, the computer-readable storage medium may be the memory 1332 including program instructions which are executable by the processor 1322 of the electronic equipment 1300 to perform the resource allocation method performed by the resource management server.

The preferred implementations of the present disclosure are described in detail above with reference to the accompanying drawings. However, the present disclosure is not limited to the specific details in the above implementations, and various simple modifications may be made to the technical solution of the present disclosure within the technical idea of the present disclosure, and these simple modifications all belong to the protection scope of the present disclosure.

Furthermore, it should be noted that the various specific technical features described in the foregoing implementations may be combined in any suitable manner without contradiction. To avoid unnecessary repetition, the present disclosure does not separately describe various possible combinations.

In addition, any combination of various implementations of the present disclosure may be made, and the same should be considered as the disclosure of the present disclosure as long as it does not depart from the gist of the present disclosure.

1. A resource allocation method applied to a terminal equipment, comprising:
sending a resource application request to a resource management server, wherein the resource application request comprises grouping information of processes running on the terminal equipment, and the grouping information is used by the resource management server to select, from a preset resource pool, resources allocated to each group of processes indicated by the grouping information;
receiving resources returned by the resource management server, and allocating the received resources to each group of processes;
wherein the method further comprises: before sending the resource application request to the resource management server,
determining a target grouping mode of the processes running on the terminal equipment according to task attribute and computation amount of computing tasks currently executed by the terminal equipment and a preset corresponding relationship among the task attribute, the computation amount and the grouping mode; and
dividing the processes running on the terminal equipment into one or more application groups according to the target grouping mode.

2. (canceled)

3. The method according to claim 1, wherein the grouping mode comprises:
taking each process as one application group;
dividing processes belonging to the same process group into one application group;
dividing processes belonging to the same session into one application group;
dividing processes belonging to the same user into one application groups; and
dividing all the processes into one application group.

4. The method according to claim 1, wherein the grouping information comprises identification information of each application group;
the method further comprises: before sending the resource application request to the resource management server,
for any application group, determining the identification information of the application group by:
generating a universal unique identifier (UUID) according to identification information corresponding to the target grouping mode and process information in the application group, and taking the UUID as the identification information of the application group; or
splicing the identification information corresponding to the target grouping mode, the process information in the application group, and identification information of the operating system of the terminal equipment to obtain the identification information of the application group.

5. A resource allocation method applied to a resource management server, comprising:
in response to receiving a resource application request sent by a terminal equipment, selecting, from a preset resource pool, resources allocated to each group of processes indicated by grouping information in the resource application request according to the grouping information;
sending the selected resources to the terminal equipment to indicate the terminal equipment to allocate the resources to each group of processes;
wherein each group of processes are grouped according to a target grouping mode, and the target grouping mode is determined according to task attribute and computation amount of computing tasks currently executed by the terminal equipment and a preset corresponding relationship among the task attribute, the computation amount and the grouping mode.

6-10. (canceled)

11. A non-transitory computer-readable storage medium, on which computer programs are stored, wherein the programs implement the steps of the method according to claim 1 when being executed by a processor.

12. An Electronic equipment, comprising:
a memory, having computer programs stored thereon; and
a processor, configured to execute the computer programs in the memory and configured to:
send a resource application request to a resource management server, wherein the resource application request comprises grouping information of processes running on the terminal equipment, and the grouping information is used by the resource management server to select, from a preset resource pool, resources allocated to each group of processes indicated by the grouping information;
receive resources returned by the resource management server, and allocating the received resources to each group of processes;
wherein the processor is further configured to: before sending the resource application request to the resource management server,
determine a target grouping mode of the processes running on the terminal equipment according to task attribute and computation amount of computing tasks currently executed by the terminal equipment and a preset corresponding relationship among the task attribute, the computation amount and the grouping mode; and
divide the processes running on the terminal equipment into one or more application groups according to the target grouping mode.

13. The Electronic equipment according to claim 12, wherein the grouping mode comprises:
taking each process as one application group;
dividing processes belonging to the same process group into one application group;
dividing processes belonging to the same session into one application group;
dividing processes belonging to the same user into one application groups; and
dividing all the processes into one application group.

14. The Electronic equipment according to claim 12, wherein the grouping information comprises identification information of each application group;
the processor is further configured: before sending the resource application request to the resource management server,
for any application group, determine the identification information of the application group by:
generating a universal unique identifier (UUID) according to identification information corresponding to the target grouping mode and process information in the application group, and taking the UUID as the identification information of the application group; or
splicing the identification information corresponding to the target grouping mode, the process information in the application group, and identification information of the operating system of the terminal equipment to obtain the identification information of the application group.

15. A non-transitory computer-readable storage medium, on which computer programs are stored, wherein the programs implement the steps of the method according to claim 5 when being executed by a processor.

16. An Electronic equipment, comprising:
a memory, having computer programs stored thereon; and
a processor, configured to execute the computer programs in the memory to implement the steps of the method according to claim 5.
